(19) United States
(12) Patent Application Publication
(10) Pub. No.: US 2025/0046212 A1
(43) Pub. Date: Feb. 6, 2025

(54) Split Line Braille System

(71) Applicant: Freedom Scientific, Inc., Clearwater, FL (US)

(72) Inventors: Joseph Kelton Stephen, Winkleigh (AU); Glen Gordon, Madison, WI (US); James T. Datray, Louisville, KY (US)

(21) Appl. No.: 18/793,831

(22) Filed: Aug. 4, 2024

Related U.S. Application Data
(60) Provisional application No. 63/517,654, filed on Aug. 4, 2023.

(51) Int. Cl. G09B 21/02

(52) U.S. Cl. CPC G09B 21/02

(57) ABSTRACT

The invention is a system designed to improve accessibility for low vision users through a Braille display. The system includes a Braille display, a split line feature, a processor, and an information source. The Braille display can present a predetermined number of different characters. The split line feature, integrated within the display or managed by software, divides the display into two distinct regions. The processor independently controls the content displayed in each region. The information source provides at least two different sets of data to the processor, which are sent to the two distinct regions simultaneously. The processor manages the regions transparently and interprets keyboard inputs based on the context. The system also includes a focus-setting mechanism, allowing users to manipulate content placement within the regions. The processor can also simulate a two-line display when a user engages a dialog for multiline views while using a single-line display.

### CROSS REFERENCE TO RELATED APPLICATION

This application is a U.S. Non-Provisional patent application which claims priority to provisional application Ser. No. 63/517,654 filed Aug. 4, 2023, and entitled “Split Line Braille System.”

### BACKGROUND OF THE INVENTION

### 1. Field of Invention

The described embodiments relate generally to accessibility software for low-vision users of computing devices. More specifically, the described embodiments pertain to a Braille display enhancement with a split-line feature that allows simultaneous presentation of two separate streams of content, such as a document's text and its associated annotations, enhancing the accessibility and information processing capabilities for visually impaired users.

### 2. Background

Braille displays, since their inception, have been an invaluable tool for people with visual impairments. They offer a way to interact with digital text by translating the information into a tactile format. A refreshable Braille display is a computer peripheral that connects to a computing device. One of the key functions of refreshable Braille displays is to output text that would normally be displayed on a computer screen as lines of Braille characters. Refreshable Braille displays enable blind and visually impaired users to read electronic documents and operate computer applications using Braille. A refreshable Braille display typically contains one or more lines of Braille cells, wherein each cell can be used to output a Braille character corresponding to an alphanumerical character. A screen reader software, such as JAWS®, can be installed on a computing device to output text onto a refreshable Braille display.

However, traditionally, these displays have had a significant limitation—they could only present a single stream of content at a time. This constraint can often pose difficulties for users, particularly when they need to process and interact with multiple layers of textual information concurrently.

Take the example of an annotated Word document. In the past, a visually impaired user would need to toggle between the main text and any associated comments or annotations, effectively breaking the continuity of their reading experience. This process was time-consuming and could potentially disrupt comprehension and workflow. It made working with complex documents, especially those involving collaborative editing or extensive annotation, particularly challenging.

In the broader context, this limitation also had implications on how visually impaired people interacted with digital platforms. The inability to present multiple streams of information simultaneously presented a barrier to efficient multitasking, impacting productivity and potentially limiting the participation of visually impaired individuals in various professional and educational activities.

The problem was further compounded by the increasing complexity and interactivity of digital content. As digital literacy became more important and the digital world became more intertwined with all aspects of life, the demand for more sophisticated and flexible Braille display technologies grew.

### SUMMARY OF THE INVENTION

The invention is an enhancement to screen reader application just as those provided under the JAWS brand. JAWS, for example, includes three distinct modes for Braille output—structured mode, line mode, and speech output mode. Each of these modes can be customized in the Settings Center.

The structured mode offers highly personalized Braille output for recognized Windows and custom controls. These controls are viewed as a set of components, each outputting a distinct piece of data depending on the control type. Users have the flexibility to enable or disable components and arrange them based on their preference. Moreover, they can pan by component segment and select which component should be initially focused on when there are more components than can fit on the display.

The line mode replicates on-screen text in Braille, incorporating an approximation of the whitespace between text elements. It also facilitates the display of attribute indicators for each character on the line, such as ‘b’ for bold, ‘i’ for italic, ‘u’ for underline, and so on. These indicators are rotated when a character has more than one such attribute. However, it does not support the simultaneous display of specific attributes and the text to which they apply.

The speech output mode translates a live speech history into Braille, allowing the user to review and pan through it.

By default, JAWS uses the structured Braille mode, but users can opt for line mode or speech output mode. When JAWS operates in either line mode or speech output mode, Braille is displayed exclusively in the chosen mode. If set to structured mode, JAWS determines whether to present the focus in structured mode or line mode. If JAWS can't recognize the type of control in focus, or the focus is on a multiline document (where line mode is deemed more appropriate), the structured mode automatically reverts to line mode.

This invention significantly enhances the capabilities of a Braille display by facilitating simultaneous Braille output from two different locations. It introduces expanded views for line mode and packaged choices for structured mode, offering Braille users a level of flexibility previously unavailable. Users can now create multiple structured Braille views tailored to specific scenarios and choose which views to use for those scenarios. Moreover, the invention introduces Braille translation comparison views, useful for training purposes or comparing Braille translation tables.

### BRIEF DESCRIPTION OF THE DRAWINGS

For a fuller understanding of the invention, reference should be made to the following detailed description, taken in connection with the accompanying drawings, in which:

FIG. 1a is a diagrammatic view of an embodiment of the invention showing a split Braille display outputting text content but no font styling attributes for the output text.

FIG. 1b is a diagrammatic view of an embodiment of the invention showing a split Braille display outputting text content and also concurrently conveying text stylization on the same display.

FIG. 2 is a diagrammatic view of an embodiment of the invention showing a split Braille display outputting a word in Grade 1 U.S. Braille while concurrently on the same display outputting the same word in Grade 2 U.S. Braille.

FIG. 3 is a diagrammatic view of an embodiment of the invention showing a split Braille display outputting text from a first application while concurrently outputting a call notification from a second telephony application.

FIG. 4 is a diagrammatic view of an embodiment of the invention showing a split Braille display outputting text from a first application while concurrently outputting a text notification from a second messaging application.

FIG. 5 is a diagrammatic view of an embodiment of the invention showing a split Braille display outputting text from a first application while concurrently outputting a text notification from a second application with two cells set to separate each Braille display output content.

### DETAILED DESCRIPTION OF THE PREFERRED EMBODIMENT

This invention pertains to a system designed to enhance accessibility for blind users by utilizing a Braille display. The key component is a Braille display, capable of exhibiting a set number of different characters. The unique attribute of this system is a split line feature, integrated within or software managed for the Braille display, which divides the display into two distinct sections. The system includes a processor, linked with the Braille display, and responsible for independently controlling the content displayed in each area of the split display.

The processor connects with a source of information, capable of supplying at least two different pieces of data to the processor. The processor can then send these two different pieces of information to the two distinct areas of the Braille display concurrently. This allows the blind user to access and understand two different pieces of content simultaneously on the Braille display.

Before this invention, the reading experience of a blind user was rather linear, as current technologies like JAWS or Narrator output annotations replacing the entire display content, causing the user to lose the context of what the annotation pertains to. The system also overcomes the limitation of existing features that split distinct outputs along a single line of Braille. While some configurations display the time as part of the display, they cannot offer the simultaneous information view that a sighted person can get from two different sources.

An aspect of the invention includes managing independent regions so that whether a single line display or a multiline display is connected, the regions are handled transparently, and the interaction via keyboard input is correctly interpreted given the context of the application state and focus. All of this is achieved in software so that any single line display is usable to show the dual regions, and when one region is updated, it does not cause dot flicker on the other region.

The use cases for this system are significant. For instance, a student is able to refer to a question while composing an answer, which is particularly useful in complex tasks such as solving math equations. Other applications include comparison of product specifications, proofreading and comparing manuscripts or revisions, and referencing material while composing an essay, among others. This invention aims to transform the accessibility landscape by providing enhanced functionality to Braille displays, hence improving the user experience for blind individuals.

Implementation of the split view is achieved through a software approach in which a container object serves as the intermediary between the Braille subsystem and its child objects. Each child object represents an individual line of Braille display. The container merges all dots from every line and forwards a combined representation to the original single line display driver. In return, when keystrokes from the display are received, the container delegates the interaction to the appropriate child region object. This is determined based on the specific location on the display where the interaction originated.

One of the features of this system is its ability to divide a line of Braille display into two distinct regions. Although it is possible to allocate an arbitrary split, in practice, these regions are designed to be symmetrical. The system automatically segments the single line into two equal parts, demarcated by a distinct region separator dot pattern. This ensures clarity in identifying where the two regions are separated. For example, if the Braille display consists of 80 cells, two regions of 38 cells are created, with a two-cell separator serving as the delimiter.

The system also facilitates a unique focus-setting mechanism. Users can manipulate the content's placement within these regions via display hotkeys or a button within the SetBrailleView dialog. This allows for a customizable reading experience, where questions can be set to appear on the left, and answers on the right, for example. It is further anticipated that under this invention, content can be split across two separate applications, such as Chrome and Word.

### Simulated Two Line Mode

If the user engages the Set Braille View dialog for multiline views such as Buffered, JAWS cursor Split, or any view other than Wrapped while using a single-line display, the display will be divided to simulate a two-line display. This functionality allows for features such as the Buffered mode and other split modes to be made available to users of single-line displays, even though not all split modes may be beneficial when used with a single line. Buffered mode, in particular, stands to be extremely advantageous in this context. The main text area of the single-line display will be bisected, with a two-cell indicator demarcating the two halves. If a user wishes to revert to a single-line mode, they can do so by selecting the “No Split” option.

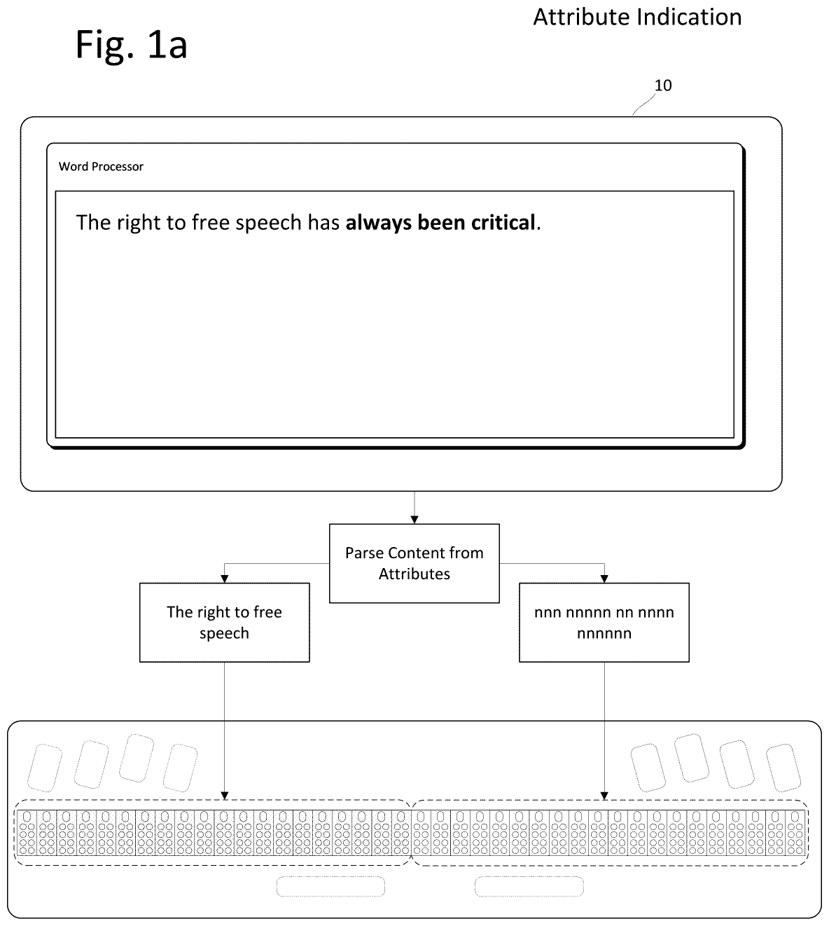

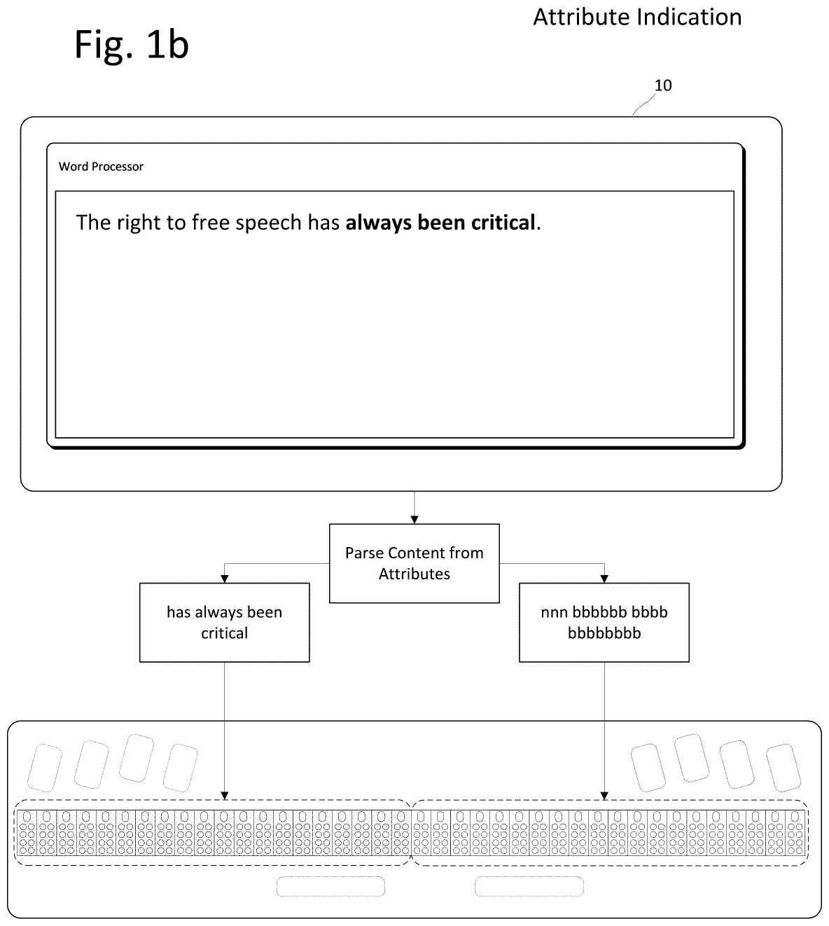

Turning now to the figures, Figure 1a shows a word processor having the text “The right to free speech has always been critical.” The last three words, “always been critical” are stylized in bold font. According to an embodiment of the invention, the content from the word processor (the stylized text) is parsed. For the Braille display, when the first portion of the text is output to the left 20-cells there is an indicium of normal (or unstylized) output to the right 20-cells (e.g., “n”). This is useful to the user in that they understand there is no stylization of the text they are reading on the left 20-cells. However, in FIG. 1b, the text “always been critical” is output to the left 20-cells partition. Now, the right 20-cells outputs information on the text stylization concurrently. In the example, instead of outputting an “n” for normal a “b” is output for bold stylization of the character. This enables the user to understand simultaneously the content and the stylization together. Furthermore, it is noteworthy that the entire process maintains the right 20-cells for stylization. Therefore, the presence and absence of stylization output to the 20-cells conveys important information to the user about what text is emphasized by the author.

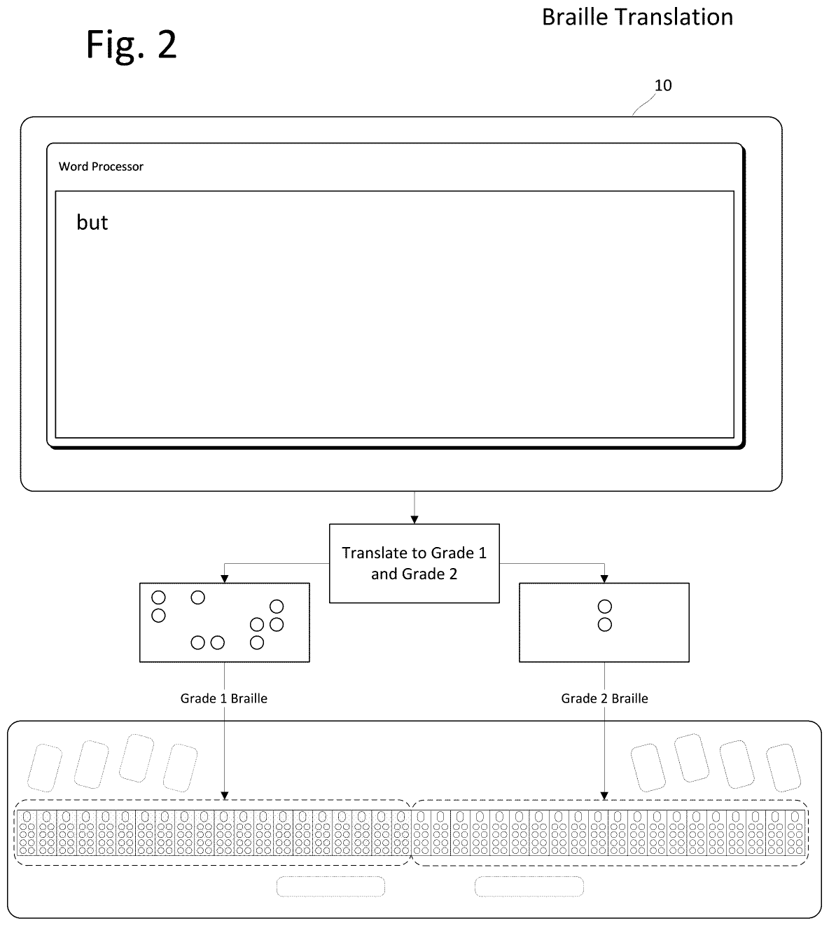

Another application of the invention, namely Braille translation, is shown in FIG. 2. Here the single word “but” in grade 1 Braille is a character-by-character translation of each alphanumeric character to Braille. However, as Braille users become more advanced, they may prefer the efficiency (and terseness) of grade 2 Braille. In grade 2, the same word “but” is shorted to be presented on a single Braille cell. The end-user-transition between grade 1 and grade 2 Braille is facilitated by the split partition Braille method claimed herein where the end user receives a real-time translation in a more advanced Braille grade.

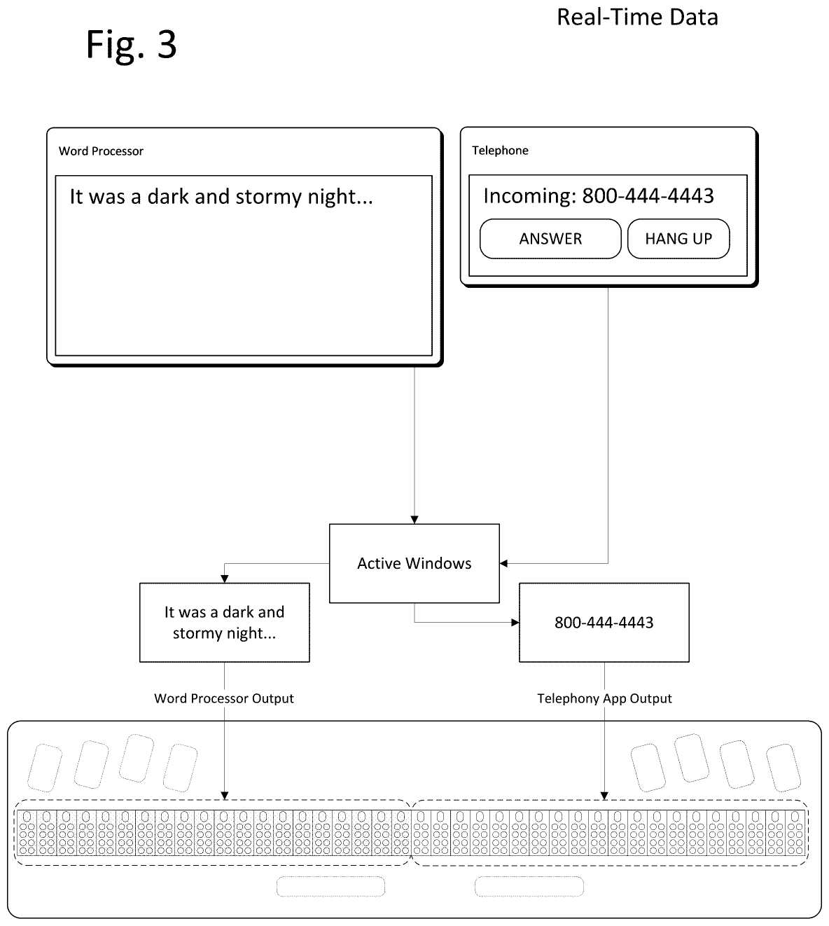

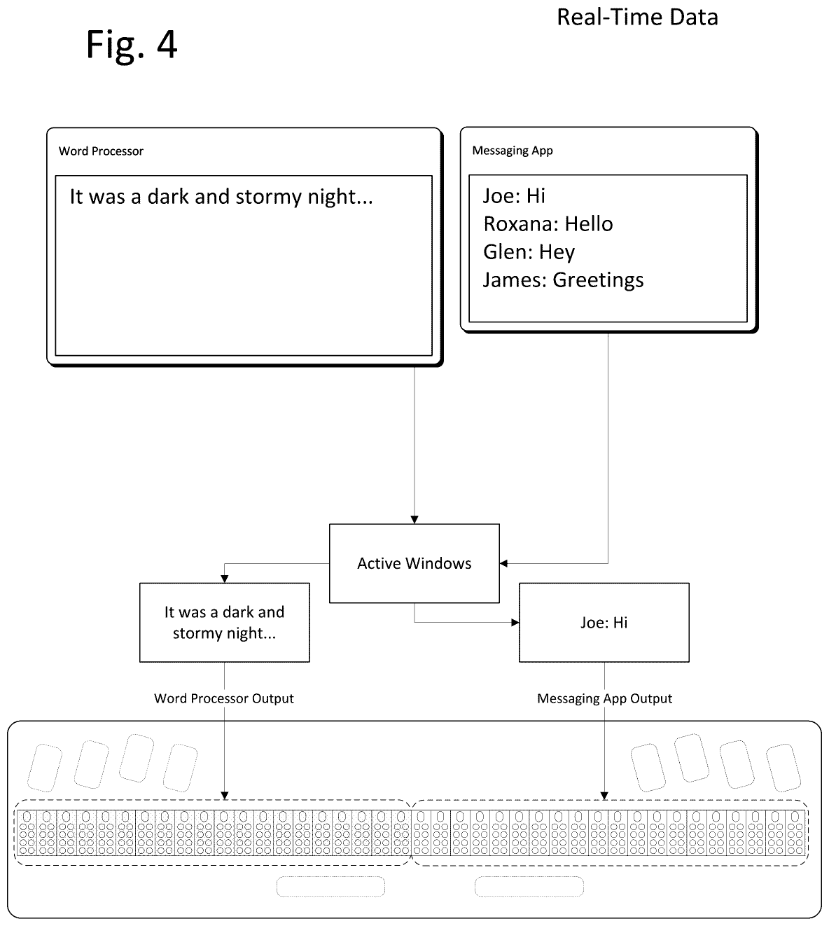

FIG. 3 shows real-time data output from independent applications. In this example, word processor text “it was a dark and stormy night . . . ” is output to the left 20-cells of Braille display. However, the end user may want to maintain knowledge of system notifications which are output to the right 20-cells of Braille display. In this example, an incoming caller-id string from a telephony application is sent to the right 20-cells. Similarly, in FIG. 4, output from a messaging application is sent to the right 20-cells while the user maintains focus and context for the word processing application in the left 20-cells.

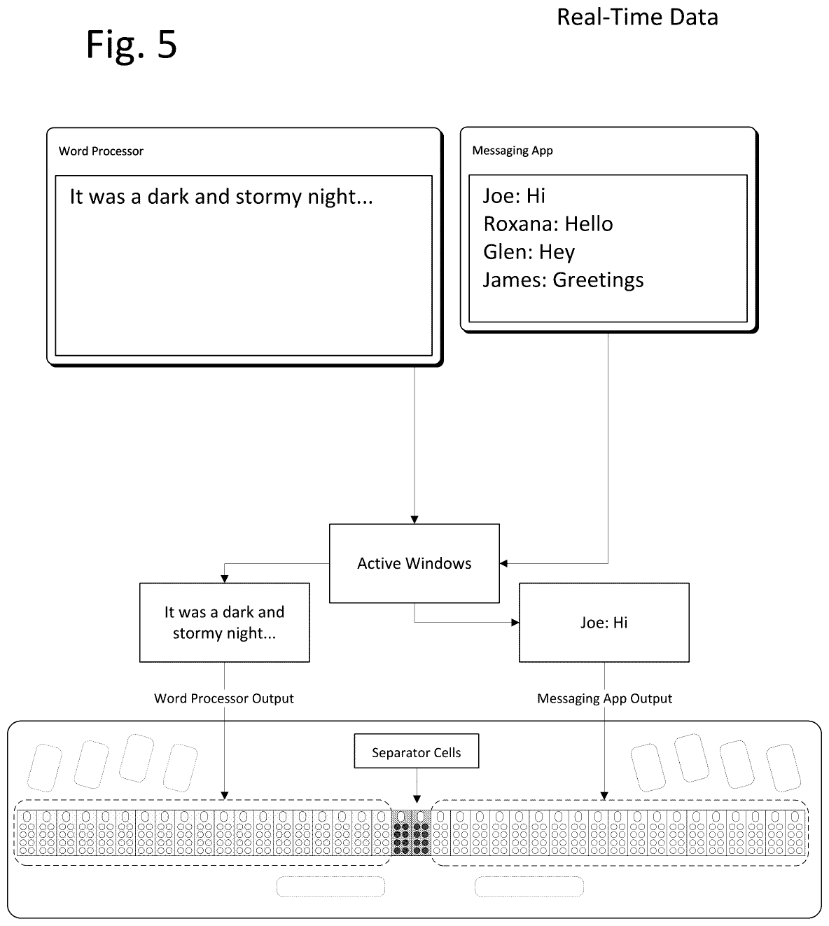

FIG. 5 shows an embodiment of the invention wherein the two Braille cells that bifurcate the left and right partitions are reserved to more clearly delineate the two different partitions.

### COMPUTER AND SOFTWARE TECHNOLOGY

The present invention may be embodied on various platforms. The following provides an antecedent basis for the information technology that may be utilized to enable the invention.

Embodiments of the present invention may be implemented in hardware, firmware, software, or any combination thereof. Embodiments of the present invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The machine-readable medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a computer readable storage medium and that can communicate, propagate, or transport a program for use by or in connection with an instruction execution system, apparatus, or device. However, as indicated above, due to circuit statutory subject matter restrictions, claims to this invention as a software product are those embodied in a non-transitory software medium such as a computer hard drive, flash-RAM, optical disk or the like.

Program code embodied on a machine-readable medium may be transmitted using any appropriate medium, including but not limited to wireless, wire-line, optical fiber cable, radio frequency, etc., or any suitable combination of the foregoing. Machine-readable program code for carrying out operations for aspects of the present invention may be written in any combination of one or more programming languages, including an object-oriented programming language such as Java, C#, C++, Visual Basic or the like and conventional procedural programming languages, such as the “C” programming language or similar programming languages. Additional languages may include scripting languages such as PYTHON, LUA and PERL.

Electronic Braille displays form an integral part of technology that makes digital content accessible for individuals with visual impairments. These displays provide tactile representation of textual information that is presented on a computer screen, translating traditional text into a Braille format which can be read by touch. Different types of electronic Braille displays exist, with operational mechanics varying depending on their design and intended use.

Some electronic Braille displays implement hardware-based solutions. These hardware Braille displays comprise an array of small pins or dots which can be raised or lowered to form Braille characters. Each dot corresponds to one of the six dots used in a Braille cell. When a new line of text is loaded into the display, the corresponding dots rise to form the Braille characters, which the user can read by moving their fingers over the dots. The exact mechanism for raising and lowering these pins can vary, but may involve the use of solenoids, piezoelectric actuators, or other electromechanical components. In firmware-implemented Braille displays, the hardware device includes firmware or embedded software which is stored in a non-volatile memory. This firmware directly controls the operations of the display, including translating incoming text into Braille and controlling the movement of the Braille dots.

Electronic Braille displays may also be fully software-implemented. These solutions typically involve specialized software running on a standard computer or portable device, often coupled with a hardware component that provides the tactile Braille output. The software manages the translation of on-screen text into Braille and updates the display as the on-screen text changes. A combination of the hardware, firmware, and software can also be used to enhance the capabilities of the electronic Braille display. For instance, software on the computer may manage translation of text into Braille and the interface with the user, while firmware embedded in the display handles lower-level control of the Braille dots. Electronic Braille displays may function based on instructions stored on a machine-readable medium. The instructions may be executed by one or more processors, with the machine-readable medium including but not limited to ROM, RAM, magnetic disk storage media, optical storage media, flash memory devices, and others. Information storage or transmission can take various forms, such as electrical, optical, acoustical, or other forms of propagated signals like carrier waves, infrared signals, digital signals, and more.

Screen readers are sophisticated software applications that gather on-screen information using multiple techniques, transforming it into tactile feedback via electronic Screen readers collect this information in a number of ways.
DOM (Document Object Model) Inspection: Utilized primarily for web content, this process entails the browser generating a DOM, which is an object-oriented representation of a web page. The screen reader accesses this DOM, creating an internal representation or ‘off-screen model’ of the page. It analyzes this model, determining the sequence of content based on aspects like HTML structure or ARIA roles, and then translates this information into Braille.
Graphics Driver or Operating System Hooking: Typically used for desktop applications where there's no DOM available, this method involves the screen reader intercepting data from the graphics driver or the operating system. When an application requests to display text on the screen, the request is sent to the graphics driver via the operating system. The screen reader hooks into this process, capturing the text content and converting it into Braille.
GUI (Graphical User Interface) Presentation Inspection: In this method, the screen reader interacts directly with the operating system's presentation layer, drawing information from GUI libraries, rendering engines, or windowing systems. This technique can provide in-depth visual data such as window positions, text content, and other visible components.
Operating System Messaging or Event Hooks: The screen reader taps into the operating system's messaging or event systems, monitoring actions like opening a new window, generating a dialog box, or presenting text. Interceptions happen in real-time, allowing the screen reader to rapidly translate these actions into Braille.
Accessibility SDKs (Software Development Kits) or Standards: These are provided by software vendors and operating systems to enhance the compatibility of their software with assistive technologies. Microsoft's UI Automation (UIA) and Apple's Accessibility API are excellent examples. UIA is a set of APIs that allows a screen reader to access and manipulate other software UIs, while Apple's API provides similar functionality.
ARIA (Accessible Rich Internet Applications) Roles and Properties: ARIA is a set of attributes that enhance web content and application accessibility. These attributes provide supplementary information about on-screen elements, contributing to the data collected by the screen reader.

By leveraging these diverse methods, screen readers can gather comprehensive information, translating and forwarding it to electronic Braille displays. Consequently, users get a thorough and dynamic understanding of the on-screen content in a tactile form they can understand and interact with.

### GLOSSARY OF CLAIM TERMS

Braille display means an electronic device that enables people with visual impairments to read text on a computer screen or other digital devices. Instead of displaying information visually, the text is converted into Braille—a system of raised dots which can be felt with the fingertips. A Braille display typically consists of a grid of tiny pins, which can move up and down to form Braille characters (combinations of six or eight dots). These characters represent letters, numbers, and other symbols, allowing users to read by touch. Each set of dots is called a “cell”, and a Braille display typically has between 12 and 80 cells, though some larger models may have more. The device is connected to a computer or another digital device and works in tandem with screen reading software, which converts the on-screen text into Braille in real-time. Braille displays can be standalone devices or can be integrated into computer keyboards or mobile devices. In addition to text reading, some Braille displays also feature basic input functionality, allowing users to type in Braille which the computer then translates into standard text.
Container (or container object) means a type of data structure that holds and organizes multiple elements or objects. These elements can be of various types such as integers, strings, or even instances of other classes or objects. The purpose of a container is to provide a way to store, manage, and manipulate collections of data in a structured and consistent manner. This includes various operations like adding or removing elements, iterating over elements, sorting, searching, and more. Containers can come in different forms and structures, depending on the specific requirements of the data they are handling. Some examples of container types include arrays, lists, sets, maps, stacks, and queues. In essence, a container object helps to manage complexity in a program by providing a unified interface for working with collections of data.
Data Structure means a data store framework for saving, querying and returning data.
Event Handler or Listener means a callback subroutine that handles inputs received in a program.
Focus refers to the active element or control that is currently selected and ready to receive input from the user. It indicates which component or area of the user interface has the keyboard input focus or is in a state of being interacted with. When an element or control has focus, it typically means that it will respond to user actions such as typing, pressing keys, or receiving specific commands. The focused element may visually stand out, such as by being highlighted or outlined, to indicate its active state. Focus is an important concept in user interface accessibility, as it allows users to navigate and interact with applications efficiently, particularly when using keyboard-based input methods or assistive technologies like screen readers. Users can typically move the focus between different elements or controls using keyboard shortcuts, tabbing, or other navigation mechanisms provided by the software or application.
Hotkey (or keyboard shortcut) means a specific key or a combination of keys that provides quick access to a particular function within the software. By using hotkeys, users can perform actions more efficiently than navigating through menus or interface buttons. For example, a hotkey might allow a user to read from the current cursor position, read the entire document, or jump between headings on a webpage without using the mouse. Screen reader hotkeys can be especially useful for low vision users or blind users, as they can provide a more efficient and accessible way to navigate through digital content.
Low vision means a significant visual impairment that can't be fully corrected with standard eyeglasses, contact lenses, medicine, or surgery. Low vision can make it difficult to perform everyday activities, such as reading, shopping, cooking, writing, and watching television. People with low vision often benefit from various types of visual aids, including lighted handheld magnifiers, digital magnifiers, bioptic telescopes, and (in the case of this invention) Braille displays.
Screen Reader means assistive technology for low vision or blind users that generates text and image content as Braille or speech (audible) output.
User Interface (UI) means a rendered display of controls, dialogs and information generated by a computing device.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by machine-readable program instructions.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A system for enhancing accessibility for low vision users through a Braille display, comprising:
a Braille display capable of presenting a predetermined number of different characters;
a split line feature, integrated within the Braille display or managed by a software application, dividing the Braille display into two distinct regions;
a processor, communicatively coupled with the Braille display, capable of controlling independently the content displayed in each region of the Braille display; and
a source of information, communicatively coupled with the processor, capable of providing at least two different sets of data to the processor, wherein the processor is configured to send the two different sets of data to the two distinct regions of the Braille display simultaneously, wherein the split line feature enables the low vision user to access and understand two different pieces of content simultaneously on the Braille display.

2. The system of claim 1, wherein the processor is configured to manage the independent regions such that whether a single line display or a multiline display is connected, the regions are handled transparently, and interaction with the display via keyboard input is interpreted given the context of the application state and focus.

3. The system of claim 1, wherein a container object serves as an intermediary between the Braille subsystem and its child objects, each child object representing an individual line or region of the Braille display.

4. The system of claim 3, wherein the container object combines all dots from all lines and forwards a combined representation to the original single line display driver, and delegates interactions from the display to the appropriate child region object based on the specific location on the display where the interaction originated.

5. The system of claim 1, wherein the split line feature is configured to divide a line of Braille display into two distinct regions of equal size, separated by a distinct region separator dot pattern.

6. The system of claim 1, further including a focus-setting mechanism configured to allow users to manipulate the placement of content within the regions via display hotkeys or a button within a dialog.

7. The system of claim 6, wherein the focus-setting mechanism allows the user to set questions to appear on one region and answers on the other region.

8. The system of claim 1, wherein the processor is further configured to enable splitting of content across two separate applications.

9. The system of claim 1, wherein the processor is configured to simulate a two-line display when a user engages a dialog for multiline views while using a single-line display.

10. The system of claim 1, wherein the first region of the split line feature displays attribute indicators related to the text in the second region, the attribute indicators being static while the text in the second region may change.

11. The system of claim 10, wherein the attribute indicators include, but are not limited to, text formatting attributes, text color attributes, or text style attributes.

12. The system of claim 1, wherein the first region of the split line feature presents a static variant of Braille translation, providing an alternative understanding of the text displayed in the second region.

13. The system of claim 1, wherein the processor is further configured to manage the static and dynamic content in the two distinct regions independently, allowing updates to the dynamic content without altering the static content.
